(19) United States
(12) Patent Application Publication
(10) Pub. No.: US 2009/0179352 A1
(43) Pub. Date: Jul. 16, 2009

(54) METHOD FOR TREATING MOLDING SURFACE OF CORE INSERT

(75) Inventor: GA-LANE CHEN, Santa Clara, CA (US)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/164,424

(22) Filed: Jun. 30, 2008

(30) Foreign Application Priority Data
Jan. 16, 2008 (CN) 200810300122.7

(51) Int. Cl. B29C 33/38

(52) U.S. Cl. 264/400

(57) ABSTRACT

A method for forming a pattern in a molding surface of a core insert, includes steps: placing a core insert on a support, the core insert having a molding surface; forming a pattern in the molding surface of the core insert using a femto-second laser light beam.

### BACKGROUND

1. Technical Field

The present invention relates to a method for treating a molding surface of a core insert.

2. Description of Related Art

Optical lenses are critical components in many optical systems. They are used in many fields, such as digital cameras, optical apparatus, et al. (see “capturing images with digital still cameras”, Micro, IEEE Volume: 18, issue: 6, November-December 1998 Page(s):14-19). It is without a doubt that, surface optical quality of optical lenses is an important factor which can influence quality of optical lenses.

Most optical lenses are manufactured by a molding device. The molding device usually includes a male mold, a female mold and two core inserts respectively mounted in the male mold and the female mold. As to the core insert, the most nuclear part is molding surface, which is used to form optical lenses directly. Accordingly, the quality of the molding surface can directly influence the surface optical quality of optical lenses.

The molding surface is usually treated using a numerical control treate or a lathe. However, the numerical control treate and the lathe do always not have adequate treating precision for treating the core insert.

What is needed, therefore, is a method for treating a core insert with high treating precision.

### SUMMARY

In an exemplary embodiment of the present invention, a method for forming a pattern in a molding surface of a core insert includes steps: placing a core insert on a support, the core insert having a molding surface; forming a pattern in the molding surface of the core insert using a femto-second laser light beam.

Other advantages and novel features of the present method will become more apparent from the following detailed description of preferred embodiments, when taken in conjunction with the accompanying drawings.

### BRIEF DESCRIPTION OF THE DRAWINGS

Many aspects of the present method can be better understood with reference to the following drawings. The components in the drawing are not necessarily drawn to scale, the emphasis instead being placed upon clearly illustrating the principles of the present method. Moreover, in the drawings, like reference numerals designate corresponding parts throughout the several views.

FIG. 1 is schematic, side view of a laser treating module in use in accordance with an exemplary embodiment.

FIG. 2 is a flow chart of a method for treating a core insert using the laser treating module of FIG. 1.

FIG. 3 is schematic, cross-sectional view of the core insert treated using the method of FIG. 2.

### DETAILED DESCRIPTION OF PRESENT EMBODIMENTS

Embodiments of the present method for forming a pattern in a molding surface of a core insert will now be described in detail below and with reference to the drawings.

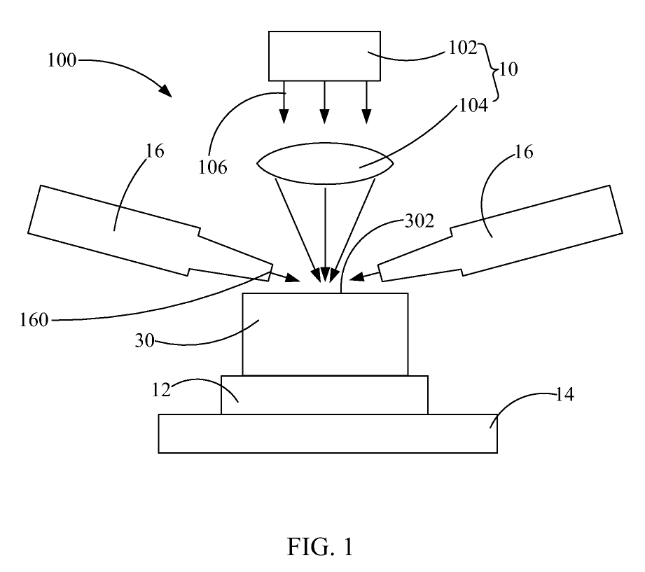

Referring to FIG. 1, a femto-second laser treating module 100 according to a first exemplary embodiment is shown. The femto-second laser treating module 100 is configured for treating a molding surface 302 of a core insert 30. The femto-second laser treating module 100 includes a femto-second laser device 10, a support 12, a support cooling member 14 and two cooling-gas ejectors 16.

The femto-second laser device 10 includes a femto-second laser generator 102 and a focusing unit 104. In the present embodiment, the femto-second laser generator 102 is but not limited to Ti: Sapphire laser. The femto-second laser generator 102 can emit a laser light beam 106 with a wavelength of 800 nanometers. The laser light beam 106 has a repetition rate in a range from 10 kHz to 250 kHz and preferably in the range from 20 kHz to 200 kHz. A pulse duration of the laser light beam 106 is in a range from 10 femtoseconds to 200 femtoseconds and is preferably in the range from 30 femtoseconds to 100 femtoseconds. The laser light beam 106 is configured for forming a pattern 304 in the molding surface 302 the core insert 30. The femto-second laser generator 102 is placed facing the support 12.

The focusing unit 104 is located facing the femto-second laser generator 102 for focusing the laser light beam 106. The focusing unit 104 can be but not limited to a convex lens.

The support 12 is placed on the support cooling member 14 and faces the femto-second laser device 10. The support 12 is configured for supporting the core insert 30 thereon. The support 12 is comprised of a material with high heat conductibility. The material of the support 12 can be stainless steel or copper.

The support cooling member 14 is configured for cooling the support 12. The support cooling member 14 can be a heat sink or a thermoelectric cooling device.

The two cooling-gas ejectors 16 are configured for generating cooling gas to cool the molding surface 302 of the core insert 30. In the present embodiment, the cooling gas generated by the cooling-gas ejector 16 is nitrogen. The cooling-gas ejector 16 has a nozzle 160 for ejecting the cooling gas from the cooling-gas ejector 16. During the process of treating the core insert 30, the nozzle 160 aims at the molding surface 302 to cool the core insert 30.

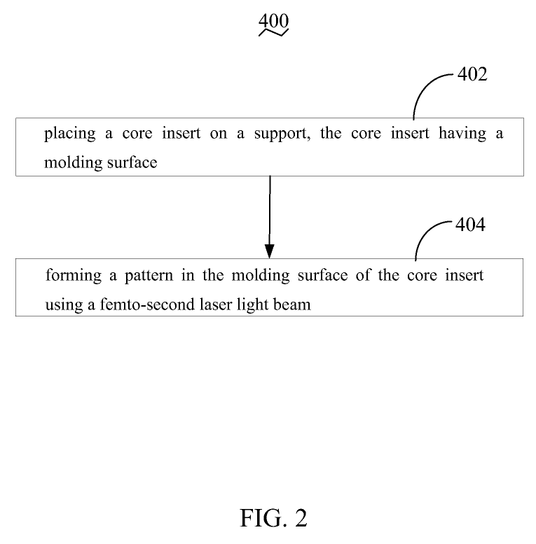

Referring to FIG. 2, a method 400 for forming a pattern in a molding surface 302 core insert using the femto-second laser treating module 100 in accordance with a second exemplary embodiment is shown. The method 400 includes following steps.

Step 402: placing a core insert on a support, the core insert having a molding surface.

Step 404: forming a pattern in the molding surface of the core insert using a femto-second laser light beam.

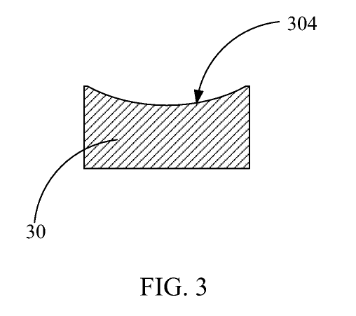

Referring to FIGS. 1 and 3, the method 400 is described in detail as follows. In step 402, the core insert 30 is disposed on the surface of the support 12 and set between the focusing unit 104 and the support 12. The support cooling member 14 is disposed under the support 12 for dissipating heat generated from the support 12. In the present embodiment, a material of the core insert 30 may be selected from the group consisting of nickel phosphide (NiP), tungsten carbide (WC) and silicon carbide (SiC).

In step 404, the femto-second laser generator 102 emits the femto-second laser beam 106 towards the focusing unit 104. The femto-second laser beam 106 is then focused by the focusing unit 104 and then irradiates on the molding surface 302 to treat the core insert 30. Meanwhile, the cooling-gas ejectors 16 eject cooling gas onto the molding surface 302 treated in order to cool the molding surface 302. The molding surface 302 of the core insert 30 is then treated by the femto-second laser beam 106 to form a pattern 304 (see FIG. 3) thereon. The temperature of the core insert 30 rises as the femto-second laser generator 102 treating the core insert 30. Because the support 12 is made of a material with high heat conductivity, the heat in the core insert 30 can be conducted to the support 12 and then be dissipated to external environment by the support cooling member 14.

When the femto-second laser beam 106 irradiates the molding surface 302 of the core insert 30, a great number of electrons will be expelled from the core insert 30. Therefore, positive ions exit from the core insert 30 at the position irradiated by the femto-second laser beam 106. The positive ions can generate a strong colomb explosion force to change the surface geometry structure of the core insert 30. The temperature of the treated surface can be kept as low as room temperature due to the laser pulse duration of the femto-second laser beam 106 is only in the range from 10 femtoseconds to 200 femtoseconds.

Referring to FIG. 3, the molding surface 302 of the core insert 30 is treated to form a pattern 304. In the exemplary embodiment, the pattern 304 is an aspheric molding surface. The profile of the aspheric pattern 304 is described by the following equation:

$$z = \frac{{cr}^{2}}{1 + \sqrt{1 - ( 1 + k ) {c}^{2} {r}^{2}}} + {a}_{1} {r}^{2} + {a}_{2} {r}^{4} + {a}_{3} {r}^{6} + … + {a}_{6} {r}^{12} ,$$

where the optic axis is presumed to lie in the z direction. The letter z is the z-component of the displacement of the surface from the vertex of the aspheric pattern 304. The letter r is a distance from the optic axis of the aspheric pattern 304. The coefficients a₁, a₂, a₃, a₄, a₅ and a₆ denote coefficients of higher orders of the above equation. The letter c denotes the curvature of the vertex of the aspheric pattern 304. The constant k is the conic constant.

It is to be understood that the molding surface 302 of the core insert 30 can also be treated by the femto-second laser treating module 100 to form a pattern with other shapes, e.g. part of a spherical surface.

The method in the present embodiment applies a femto-second laser generator 102 to generate a femto-second laser light beam 106. The temperature of the treated surface can be kept as low as room temperature due to the laser pulse duration is in a the range from 10 femtoseconds to 200 femtoseconds. Therefore, the aspheric molding surface 302 will not be subjected to thermal deformation or thermally damaged. In addition, the average roughness of the aspheric molding surface 302 can be kept in the nano scale.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for forming a pattern in a molding surface of a core insert, comprising:
placing a core insert on a support, the core insert having a molding surface;
forming a pattern in the molding surface of the core insert using a femto-second laser light beam.

2. The method as claimed in claim 1, wherein the molding surface is an aspheric surface.

3. The method as claimed in claim 1, further comprising a step of: cooling the support.

4. The method as claimed in claim 3, wherein the support is cooled using a heat sink.

5. The method as claimed in claim 1, further comprising a step of: blowing a cooling gas onto the molding surface of the core insert to cool the core insert.

6. The method as claimed in claim 5, wherein the cooling gas is a nitrogen gas.

7. The method as claimed in claim 1, wherein the femto-second laser light beam is emitted by a Ti: Sapphire laser generator.

8. The method as claimed in claim 1, wherein a repetition rate of the femto-second laser light beam is in the range from 10 kHz to 250 kHz.

9. The method as claimed in claim 1, wherein a repetition rate of the femto-second laser light beam is in the range from 20 kHz to 200 kHz.

10. The method as claimed in claim 1, wherein a pulse duration of the femto-second laser light beam is in the range from 10 femtoseconds to 200 femtoseconds.

11. The method as claimed in claim 1, wherein a pulse duration of the femto-second laser light beam is in the range from 30 femtoseconds to 100 femtoseconds.

12. The method as claimed in claim 1, wherein a wavelength of the femto-second laser light beam is about 800 nonometers.
